(19) United States
(12) Patent Application Publication
(10) Pub. No.: US 2014/0337456 A1
(43) Pub. Date: Nov. 13, 2014

(54) SYSTEMS AND METHODS FOR ENABLING RDMA BETWEEN DIVERSE ENDPOINTS

(71) Applicant: DELL PRODUCTS L.P., Round Rock, TX (US)

(72) Inventors: Gaurav Chawla, Austin, TX (US); Hendrich M. Hernandez, Round Rock, TX (US); Robert Lee Winter, Leander, TX (US)

(73) Assignee: Dell Products L.P., Round Rock, TX (US)

(21) Appl. No.: 13/888,562

(22) Filed: May 7, 2013

(51) Int. Cl. G06F 15/173

(52) U.S. Cl. CPC G06F 15/17331
USPC 709/212

(57) ABSTRACT

In accordance with embodiments of the present disclosure, a method may include determining one or more characteristics of each of two endpoints of a data transfer, the one or more characteristics comprising whether the endpoint is Remote Direct Memory Access (RDMA)-capable. The method may also include establishing an RDMA termination between the two endpoints. The method may additionally include configuring a first path between the RDMA termination and a first endpoint of the two endpoints, wherein the first path is RDMA-capable, in response to determining that the first endpoint is RDMA-capable. The method may further include configuring a second path between the RDMA termination and a second endpoint of the two endpoints.

### TECHNICAL FIELD

The present disclosure relates in general to information handling systems, and more particularly to a system and method for enabling Remote Direct Memory Access (RDMA) communication between diverse endpoints.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Direct Memory Access (DMA) is a feature in many information handling systems that allows certain hardware subsystems within the information handling system to access system memory independently of the central processing unit (CPU) of the information handling system. RDMA permits placement of data from a memory of a sending information handling system into a memory of a receiving information handling system from the sending information handling system by way of an intermediate network protocol that provides appropriate semantics for such transfers. Notable types of RDMA include Internet-capable Wide Area RDMA Protocol (iWARP), RDMA over Converged Ethernet (RoCE), and

Infiniband. An application programming interface in accordance with Open Fabrics Enterprise Distribution (OFED) supports various types of RDMA with Small Computer System Interface (SCSI) RDMA Protocol and iSCSI Extensions for RDMA (iSER) verbs for storage applications, Message Passing Interface (MPI) verbs for classical high performance computing applications, Sockets Direct Protocol (SDP) verbs for general applications, and Lustre verbs for file system applications.

Traditionally, to undertake an RDMA transfer, endpoints of the transfer must be identical on each end of a connection, and RDMA will function only if both endpoints are RDMA capable in exactly the same way, using the same network transport protocol and the same verb convention. Stated another way, RDMA communication is typically not supported between “diverse” endpoints.

### SUMMARY

In accordance with the teachings of the present disclosure, the disadvantages and problems associated with RDMA communication between diverse endpoints may be reduced or eliminated.

In accordance with embodiments of the present disclosure, a method may include determining one or more characteristics of each of two endpoints of a data transfer, the one or more characteristics comprising whether the endpoint is Remote Direct Memory Access (RDMA)-capable. The method may also include establishing an RDMA termination between the two endpoints. The method may additionally include configuring a first path between the RDMA termination and a first endpoint of the two endpoints, wherein the first path is RDMA-capable, in response to determining that the first endpoint is RDMA-capable. The method may further include configuring a second path between the RDMA termination and a second endpoint of the two endpoints.

In accordance with these and other embodiments of the present disclosure, an information handling system may include a processor, a memory communicatively coupled to the processor, a network interface communicatively coupled to the processor, and a program of instructions embodied in computer-readable media. The program of instructions may be configured to, when executable by the processor: (i) determine one or more characteristics of each of two endpoints of a data transfer, the one or more characteristics comprising whether the endpoint is Remote Direct Memory Access (RDMA)-capable, and the two endpoints communicatively coupled to the information handling system via the network interface; (ii) establishing an RDMA termination on the information handling system; (iii) configuring a first path between the RDMA termination and a first endpoint of the two endpoints, wherein the first path is RDMA-capable, in response to determining that the first endpoint is RDMA-capable; and (iv) configuring a second path between the RDMA termination and a second endpoint of the two endpoints.

In accordance with these and other embodiments of the present disclosure, an article of manufacture may include a computer readable medium and computer-executable instructions carried on the computer readable medium, the instructions readable by a processor. The instructions, when read and executed, may cause the processor to: (i) determine one or more characteristics of each of two endpoints of a data transfer, the one or more characteristics comprising whether the endpoint is Remote Direct Memory Access (RDMA)-capable, and the two endpoints communicatively coupled to the information handling system via the network interface; (ii) establishing an RDMA termination on the information handling system; (iii) configuring a first path between the RDMA termination and a first endpoint of the two endpoints, wherein the first path is RDMA-capable, in response to determining that the first endpoint is RDMA-capable; and (iv) configuring a second path between the RDMA termination and a second endpoint of the two endpoints.

Technical advantages of the present disclosure will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of a system for RDMA communication between two non-RDMA-capable endpoints with an RDMA-capable internal link, in accordance with embodiments of the present disclosure;

FIG. 2 illustrates a block diagram of a system for RDMA communication between two RDMA-capable endpoints with a non-RDMA-capable internal link, in accordance with embodiments of the present disclosure;

FIG. 3 illustrates a block diagram of a system for RDMA communication between two RDMA-capable endpoints, in accordance with embodiments of the present disclosure; and

FIG. 4 illustrates a block diagram of an example information handling system, in accordance with certain embodiments of the present disclosure.

### DETAILED DESCRIPTION

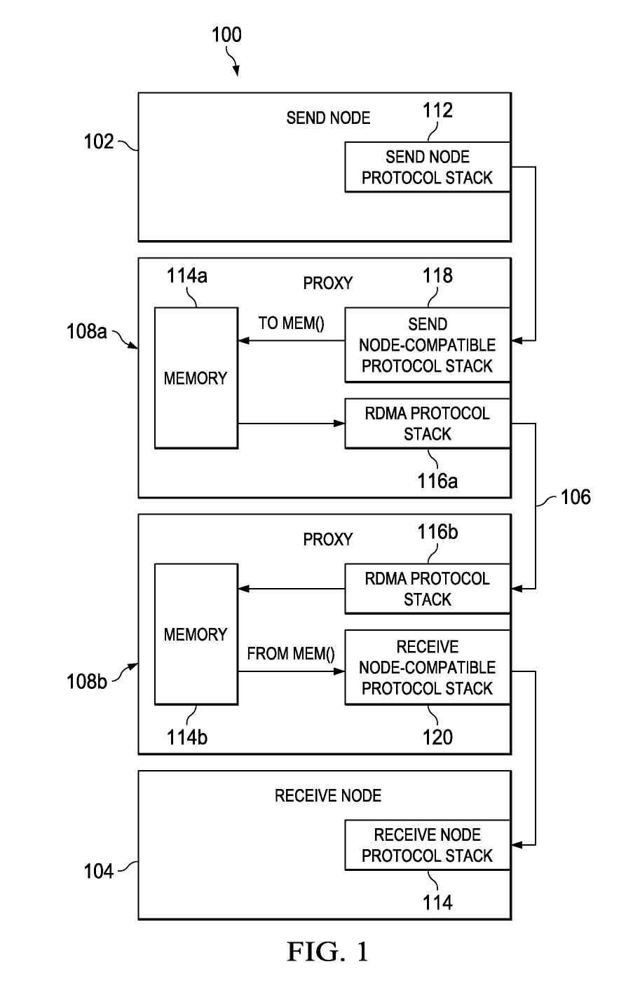

Preferred embodiments and their advantages are best understood by reference to FIGS. 1 through 4, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of a system 100 for RDMA communication between two non-RDMA-capable endpoints comprising send node 102 and receive node 104 with an RDMA-capable internal link 106, in accordance with embodiments of the present disclosure. As an example, endpoints 102 and 104 may be configured for communication via Transport Communication Protocol/Internet Protocol (TCP/IP) while internal link 106 may be configured for iWARP over Ethernet. In operation, send node 102, which may comprise an information handling system, may process and communicate data to be sent via a protocol stack 112 (e.g., a TCP/IP stack in embodiments in which send node 102 is configured for communication via TCP/IP). Such data may be received at a proxy 108a by a protocol stack 118 compatible with protocol stack 112 of send node 102. Proxy 108a may comprise an information handling system, or certain portions of proxy 108a may comprise executable instructions executing on an information handling system. Once processed by send node-compatible protocol stack 118, proxy 108a may store data to memory 114a of proxy 108a. As shown in FIG. 1, data may be stored to memory 114a using a construct “ToMem( )” which is internal to proxy 108a. In some embodiments, the construct ToMem( ) may include variables passed to it for an address of a received packet data buffer in proxy 108a, a local destination memory buffer in proxy 108a, a number of bytes in the transfer, and/or other variables.

From memory 114a, RDMA may be used to transfer the data to memory 114b of proxy 108b via RDMA protocol stacks 116a and 116b, and RDMA-capable internal link 106 (e.g., via iWARP over Ethernet in embodiments in which proxies 108a and 108b are configured for iWARP over Ethernet communication). Thus, proxy 108a may provide an RDMA termination that interfaces between a non-RDMA-capable path from send node 102 and an RDMA-capable path to proxy 108b. Proxy 108b may comprise an information handling system, or certain portions of proxy 108b may comprise executable instructions executing on an information handling system. To transfer the data to receive node 104, which may comprise an information handling system, proxy 108b may first retrieve the data from memory 114b. As shown in FIG. 1, data may be retrieved from memory 114a using a construct “FromMem( )” which is internal to proxy 108b. In some embodiments, the construct FromMem( ) may include variables passed to it for an address of a to-be-transmitted packet data buffer from proxy 108b, a local source memory buffer in proxy 108b, a number of bytes in the transfer, and/or other variables.

Once retrieved from memory 114b, proxy 108b may process the data with a protocol stack 120 compatible with protocol stack 114 of receive node 104 (e.g., a TCP/IP stack in embodiments in which receive node 104 is configured for communication via TCP/IP) and communicate the data to receive node 104 where it is processed by receive node protocol stack 114. Thus, proxy 108b may provide an RDMA termination that interfaces between a non-RDMA-capable path to receive node 104 and an RDMA-capable path from proxy 108b.

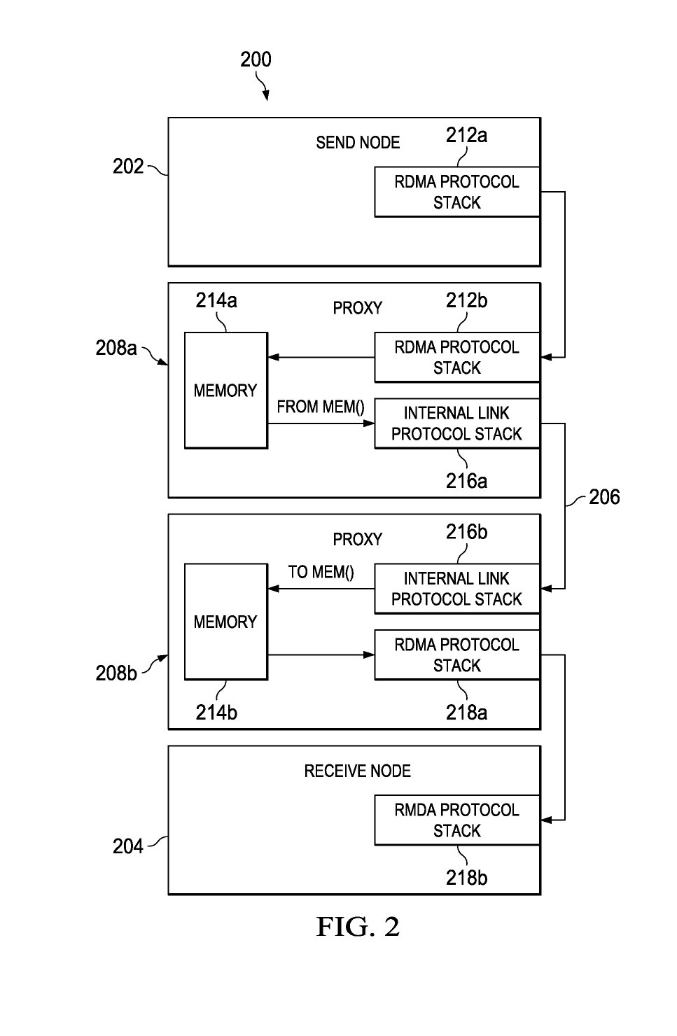

FIG. 2 illustrates a block diagram of a system 200 for RDMA communication between two RDMA-capable endpoints comprising send node 202 and receive node 204 with a non-RDMA-capable internal link 206, in accordance with embodiments of the present disclosure. As an example, endpoints 202 and 204 may be configured for communication via iWARP over Ethernet while internal link 206 may be configured for TCP/IP.

In operation, RDMA may be used to transfer data from send node 202, which may comprise an information handling system, to memory 214a of proxy 208a via RDMA protocol stacks 212a and 212b. Proxy 208a may comprise an information handling system, or certain portions of proxy 208a may comprise executable instructions executing on an information handling system. To transfer the data to proxy 208b, proxy 208a may first retrieve the data from memory 214a. As shown in FIG. 2, data may be retrieved from memory 214a using a construct “FromMem( )” which is internal to proxy 208a and may be similar to the FromMem( ) construct discussed with respect to FIG. 1 above.

Once retrieved from memory 214a, proxy 208a may process the data with a protocol stack 216a for internal link 206 (e.g., a TCP/IP stack in embodiments in which internal link 206 is configured for communication via TCP/IP) and communicate the data to proxy 208b where it is processed by a protocol stack 216b compatible with internal link protocol stack 216a. Thus, proxy 208a may provide an RDMA termination that interfaces between a non-RDMA capable path to proxy 208b and an RDMA-capable path from send node 202.

Proxy 208b may comprise an information handling system, or certain portions of proxy 208b may comprise executable instructions executing on an information handling system. Once processed by internal link protocol stack 216b, proxy 208b may store data to memory 214b of proxy 208b. As shown in FIG. 2, data may be stored to memory 214b using a construct “ToMem( )” which is internal to proxy 208b and may be similar to the ToMem( ) construct discussed with respect to FIG. 1 above. From memory 214b, RDMA may be used to transfer the data to receive node 204, which may comprise an information handling system, via RDMA protocol stacks 218a and 218b (e.g., via iWARP over Ethernet in embodiments in which receive node 204 is configured for iWARP over Ethernet communication). Thus, proxy 208a may provide an RDMA termination that interfaces between a non-RDMA capable path from proxy 208a and an RDMA-capable path to receive node 204.

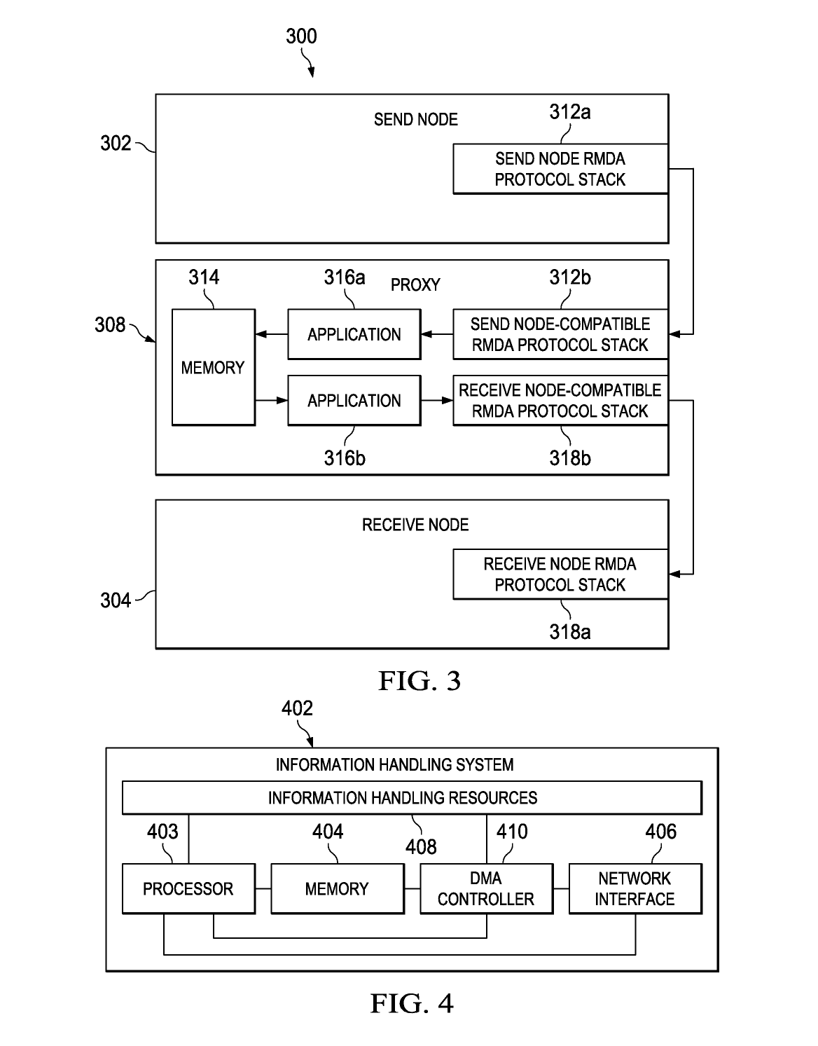

FIG. 3 illustrates a block diagram of a system 300 for RDMA communication between two RDMA-capable endpoints comprising a send node 302 and a receive node 304 employing different communication protocols, in accordance with embodiments of the present disclosure. As an example, send node 302, which may comprise an information handling system, may be configured for communication via iWARP over Ethernet while receive node 304, which may comprise an information handling system, may be configured for communication via RoCE.

In operation, RDMA may be used to transfer data from send node 302 to memory 314 of proxy 308 via a protocol stack 312a for send node 302, an RDMA protocol stack 312b compatible with send node RDMA protocol stack 312a, and an application 316a compatible with send node RDMA protocol stack 312a for storing transferred data to memory 314. Proxy 308 may comprise an information handling system, or certain portions of proxy 308 may comprise executable instructions executing on an information handling system. RDMA may be used to transfer the data to from memory 314 to receive node 304 via an application 316b compatible with receive node RDMA protocol stack 318a, an RDMA protocol stack 318b compatible with send node RDMA protocol stack 318a, and a protocol stack 318a for receive node 304. Thus, proxy 308 may provide an RDMA termination that interfaces between an RDMA capable path from send node 302 and an RDMA-capable path to receive node 304.

In operation, a proxy (e.g., proxy 108, 208, and/or 308) may be configured to dynamically determine one or more characteristics (e.g., whether or not RDMA-capable, communication protocol between endpoint and proxy) of each endpoint to which it is communicatively coupled, and based on such determination, select a communication stack in which it will communicate with each endpoint, and determine whether transfers between a memory of the proxy and the endpoint may be undertaken using RDMA or by using non-RDMA constructs (e.g., ToMem( ) and FromMem( )).

The examples set forth above are examples, and not limiting. Thus, methods and systems similar to those set forth above may be used to facilitate RDMA between any suitable set of diverse endpoints, and not just those depicted in FIGS. 1-3.

FIG. 4 illustrates a block diagram of an example information handling system 402, in accordance with certain embodiments of the present disclosure. As depicted in FIG. 4, information handling system 402 may include a processor 403, a memory 404 communicatively coupled to processor 403, a network interface 406 communicatively coupled to processor 403, one or more information handling resources 408 communicatively coupled to processor 403, and a DMA controller 410 communicatively coupled to processor 403, memory 404, network interface 406, and information handling resources 408. An information handling system 402 as depicted in FIG. 4 may be used to implement all of a part of one or more of send nodes 102, 202, and 302, one or more of received nodes 104, 204, and 304, and/or one or more of proxies 108a, 108b, 208a, 208b, and 308.

Processor 403 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 403 may interpret and/or execute program instructions and/or process data stored in memory 404 and/or another information handling resource of information handling system 402.

Memory 404 may be communicatively coupled to processor 403 and may include any system, device, or apparatus configured to retain program instructions and/or data for a period of time (e.g., computer-readable media). Memory 404 may include RAM, EEPROM, a PCMCIA card, flash memory, magnetic storage, opto-magnetic storage, or any suitable selection and/or array of volatile or non-volatile memory that retains data after power to information handling system 402 is turned off.

Network interface 406 may comprise any suitable system, apparatus, or device operable to serve as an interface between information handling system 402 and a network. Network interface 406 may enable information handling system 402 to communicate using any suitable transmission protocol and/or standard. In these and other embodiments, network interface 406 may comprise a network interface card, or “NIC.”

One or more information handling resources 408 may be communicatively coupled to processor 403 and DMA controller 410 and may include one or more processors, service processors, basic input/output systems, busses, memories, I/O devices and/or interfaces, storage resources, network interfaces, motherboards, and/or any other components and/or elements suitable for use in information handling system 402.

DMA controller 410 may be coupled to one or more of processor 403, memory 404, network interface 406, and information handling resources 408, and may comprise any system, device, or apparatus configured to facilitate, manage, or control DMA and/or RDMA operations between various components of information handling system 402.

Although the present disclosure has been described in detail, it should be understood that various changes, substitutions, and alterations can be made hereto without departing from the spirit and the scope of the disclosure as defined by the appended claims.

What is claimed is:

1. A method, comprising:
determining one or more characteristics of each of two endpoints of a data transfer, the one or more characteristics comprising whether the endpoint is Remote Direct Memory Access (RDMA)-capable;
establishing an RDMA termination between the two endpoints;
configuring a first path between the RDMA termination and a first endpoint of the two endpoints, wherein the first path is RDMA-capable, in response to determining that the first endpoint is RDMA-capable; and
configuring a second path between the RDMA termination and a second endpoint of the two endpoints.

2. The method of claim 1, further comprising configuring the second path to be RDMA-capable in response to determining that the second endpoint is RDMA-capable.

3. The method of claim 1, wherein the one or more characteristics comprise a communication protocol for which each endpoint is configured to communicate, the method further comprising configuring each of the first path and the second path based on the communication protocol for which each of the first endpoint and the second endpoint is configured to communicate.

4. The method of claim 1, further comprising transferring data of the data transfer between a memory associated with the RDMA termination and the first endpoint via RDMA.

5. The method of claim 1, further comprising transferring data of the data transfer between a memory associated with the RDMA termination and the second endpoint.

6. The method of claim 1, further comprising transferring data of the data transfer between the two endpoints via the RDMA termination.

7. An information handling system, comprising:
a processor;
a memory communicatively coupled to the processor;
a network interface communicatively coupled to the processor; and
a program of instructions embodied in computer-readable media and configured to, when executable by the processor:
determine one or more characteristics of each of two endpoints of a data transfer, the one or more characteristics comprising whether the endpoint is Remote Direct Memory Access (RDMA)-capable, and the two endpoints communicatively coupled to the information handling system via the network interface;
establishing an RDMA termination on the information handling system;
configuring a first path between the RDMA termination and a first endpoint of the two endpoints, wherein the first path is RDMA-capable, in response to determining that the first endpoint is RDMA-capable;
and
configuring a second path between the RDMA termination and a second endpoint of the two endpoints.

8. The information handling system of claim 7, the program of instructions further configured to configure the second path to be RDMA-capable in response to determining that the second endpoint is RDMA-capable.

9. The information handling system of claim 7, wherein the one or more characteristics comprise a communication protocol for which each endpoint is configured to communicate, the program of instructions further configured to configure each of the first path and the second path based on the communication protocol for which each of the first endpoint and the second endpoint is configured to communicate.

10. The information handling system of claim 7, the program of instructions further configured to transfer data of the data transfer between a memory associated with the RDMA termination and the first endpoint via RDMA.

11. The information handling system of claim 7, the program of instructions further configured to transfer data of the data transfer between a memory associated with the RDMA termination and the second endpoint.

12. The information handling system of claim 7, the program of instructions further configured to transfer data of the data transfer between the two endpoints via the RDMA termination.

13. An article of manufacture comprising:
a computer readable medium; and
computer-executable instructions carried on the computer readable medium, the instructions readable by a processor, the instructions, when read and executed, for causing the processor to:
determine one or more characteristics of each of two endpoints of a data transfer, the one or more characteristics comprising whether the endpoint is Remote Direct Memory Access (RDMA)-capable;
establish an RDMA termination between the two endpoints;
configure a first path between the RDMA termination and a first endpoint of the two endpoints, wherein the first path is RDMA-capable, in response to determining that the first endpoint is RDMA-capable;
and
configure a second path between the RDMA termination and a second endpoint of the two endpoints.

14. The article of claim 13, the instructions for further causing the processor to configure the second path to be RDMA-capable in response to determining that the second endpoint is RDMA-capable.

15. The article of claim 13, wherein the one or more characteristics comprise a communication protocol for which each endpoint is configured to communicate, the program of instructions further configured to configure each of the first path and the second path based on the communication protocol for which each of the first endpoint and the second endpoint is configured to communicate.

16. The article of claim 13, the instructions for further causing the processor to transfer data of the data transfer between a memory associated with the RDMA termination and the first endpoint via RDMA.

17. The article of claim 13, the instructions for further causing the processor to transfer data of the data transfer between a memory associated with the RDMA termination and the second endpoint.

18. The article of claim 13, the instructions for further causing the processor to transfer data of the data transfer between the two endpoints via the RDMA termination.
